(19) United States
(12) Patent Application Publication
(10) Pub. No.: US 2025/0112903 A1
(43) Pub. Date: Apr. 3, 2025

(54) Application Independent and Traffic Dependent Semantic Communication

(71) Applicant: Apple Inc., Cupertino, CA (US)

(72) Inventors: Ahmed M SOLIMAN, Munich (DE); Ahmed Gamal Helmy MOHAMED, San Jose, CA (US); Ayman F NAGUIB, Cupertino, CA (US); Danila ZAEV, Munich (DE); Kenza HAMIDOUCHE, Cupertino, CA (US); Onur SAHIN, San Diego, CA (US); Sabine ROESSEL, Munich (DE); Sudeep MANITHARA VAMANAN, Uttenreuth (DE)

(21) Appl. No.: 18/886,207

(22) Filed: Sep. 16, 2024

Related U.S. Application Data
(60) Provisional application No. 63/586,480, filed on Sep. 29, 2023.

(51) Int. Cl. H04L 9/40; G06N 5/02

(52) U.S. Cl. CPC H04L 63/0428; G06N 5/02

(57) ABSTRACT

An apparatus configured to receive input data, process, by a semantic encoder, the input data to generate a semantic representation of the input data, wherein the semantic representation comprises multiple semantic sub-flows, wherein each semantic sub-flow comprises a semantic weight corresponding to a relevance of the semantic data, process, by a communication encoder, each of the semantic sub-flows to generate semantic transmissions corresponding to the semantic sub-flows, wherein characteristics of the semantic transmissions are based on the semantic weight of the corresponding semantic sub-flow and prepare, for transmission to the receiver, the semantic transmissions.

### PRIORITY/INCORPORATION BY REFERENCE

This application claims priority to U.S. Provisional Application Ser. No. 63/586,480 filed on Sep. 29, 2023, entitled “Application Independent and Traffic Dependent Semantic Communication,” the entirety of which is incorporated by reference herein.

### BACKGROUND

Wireless communication systems are rapidly growing in usage and constantly evolving. It is anticipated that future evolutions of the cellular standards, e.g., (3GPP standards) may include aspects of semantic communication. Some goals of semantic communication may be to provide high Quality of Experience (QoE) services in bad coverage areas and optimize utilization of network resources. However, there is currently no agreed upon framework to provide semantic communications.

### SUMMARY

Some example embodiments are related to an apparatus having processing circuitry configured to receive input data, process, by a semantic encoder, the input data to generate a semantic representation of the input data, wherein the semantic representation comprises multiple semantic sub-flows, wherein each semantic sub-flow comprises a semantic weight corresponding to a relevance of the semantic data, process, by a communication encoder, each of the semantic sub-flows to generate semantic transmissions corresponding to the semantic sub-flows, wherein characteristics of the semantic transmissions are based on the semantic weight of the corresponding semantic sub-flow and prepare, for transmission to the receiver, the semantic transmissions.

Other example embodiments are related to an apparatus having processing circuitry configured to receive input data, process the input data to generate a semantic representation of the input data and generate, for transmission to a receiver, a data packet to transmit a portion of the semantic representation, wherein the data packet comprises a Traffic Dependent-Communication Optimization (TDCO) header including traffic characteristics of the semantic representation.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an overview of an example communication flow for semantic sub-flows according to various example embodiments.

FIG. 5 shows an example of assigning semantic sub-flow weights (SFW) according to various example embodiments.

FIG. 6 shows an example of an arrangement of the communication layers for semantic sub-flow transmission according to various example embodiments.

FIG. 7 shows an example of a Traffic Dependent-Communication Optimization (TDCO) layer within layer structure of a UE according to various example embodiments.

FIG. 8 shows an example TDCO header including a format of the header and example information that may be included in the TDCO header according to various example embodiments.

FIG. 9 shows an example of using the TDCO in the downlink (DL) according to various example embodiments.

FIG. 10 shows an example of using the TDCO with a packet inspection enhancement in the downlink (DL) according to various example embodiments.

FIG. 11 shows an example of using the TDCO in the uplink (UL) according to various example embodiments.

FIG. 12 shows an example of a semantic kit for an augmented reality (AR)/virtual reality (VR) application category according to various example embodiments.

FIG. 13 shows an example architecture including a communication abstraction component implemented in a MAC layer 131 according to various example embodiments.

### DETAILED DESCRIPTION

The example embodiments may be further understood with reference to the following description and the related appended drawings, wherein like elements are provided with the same reference numerals. The example embodiments relate to various aspects of semantic communication. In a first aspect, an application-independent communication design for a semantic aware and goal oriented system is provided. In a second aspect, a traffic dependent communication layer is provided for semantic communications.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network. However, reference to a 6G network is merely provided for illustrative purposes. The example embodiments may be utilized with any appropriate type of network and that supports semantic communications as described herein, including future evolutions of the cellular standards beyond 6G.

The example embodiments are related to semantic communications. Semantic communications differ from traditional or classic communications. Specifically, traditional communication modes use error-free deterministic communications, e.g., the data that is to be transmitted by a transmitter and received by a receiver is the actual data that is to be exchanged, e.g., data that represents pixel values of an image. In contrast, semantic communications are not limited to transmission of the actual data. Rather, semantic communications transmit semantic representations of the data, e.g., semantic data or metadata about the data that is to be transmitted. The receiver may use this semantic data or metadata to reconstruct the actual data that the transmitter intends without the transmitter sending the actual data.

One advantage of semantic communications is that the semantic representations of data, e.g., semantic data or metadata about the data to be transmitted, may be smaller than the actual data to be transmitted. To provide an example, the semantic representation of an image may be significantly smaller than the actual data of the image. This reduction in the amount of data required to exchange information between a transmitter and receiver may allow for higher throughputs to accommodate heavy traffic scenarios.

Semantic communications is not data compression. That is, traditional communication modes may use various compression algorithms to compress the size of the actual data, e.g., there are multiple forms of MPEG compression that reduce the size of video files for traditional communications. These forms of compression typically remove some of the actual data from the data being transmitted and the receiver may decode the compressed data using interpolation or other methods. Semantic communications are different from compression (or encoding) because the reduced amount of data used for semantic communications is not a subset of the actual data as in traditional communication compression.

To provide a very simple example of transmitting an image that includes a tree. Traditional communication modes need to represent each pixel of the image that includes the tree and transmit those representations of each pixel to the receiver. The receiver may decode the representations of each pixel and display the image. In contrast, in semantic communications, the semantic representation may be as simple as indicating a ‘tree.’ The receiver may then place a tree in the image. The semantic representation may be more complicated, e.g., ‘a tree with green leaves’, ‘a tree with fall color leaves’, ‘an oak tree’, etc. From this simple example, it can be seen that the amount of data used to convey the same information is significantly less using semantic communications.

However, because the semantic representation is not the actual data, there may be errors introduced by the semantic communications. The example embodiments use various techniques to ensure that the semantic representations of the data convey the meaning of the data from the transmitter to the receiver, e.g., the receiver reproduces output data that is as close to the input data as possible.

The example embodiments describe an application independent communication system. In the application independent communication system, a semantic encoder encodes multiple semantic sub-flows based on a relevancy of the data being represented. Each semantic sub-flow is associated with a corresponding weight and this corresponding weight may be used by the communication layers to determine the treatment for communication of each of the sub-flows.

The example embodiments also describe a traffic dependent communication layer that may be added to semantic packets to provide the communication layers with more information about traffic to enhance the performance of the communication system by considering different data characteristics.

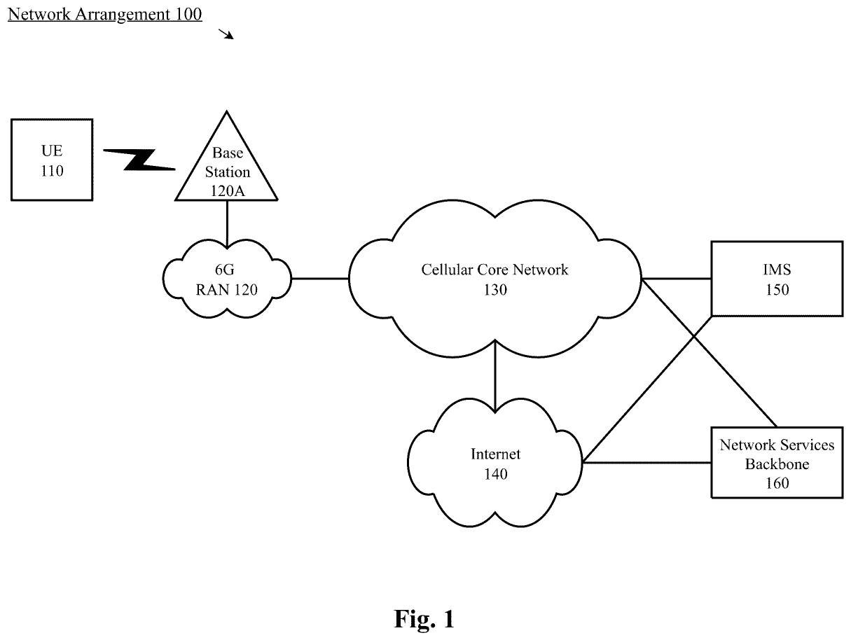

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

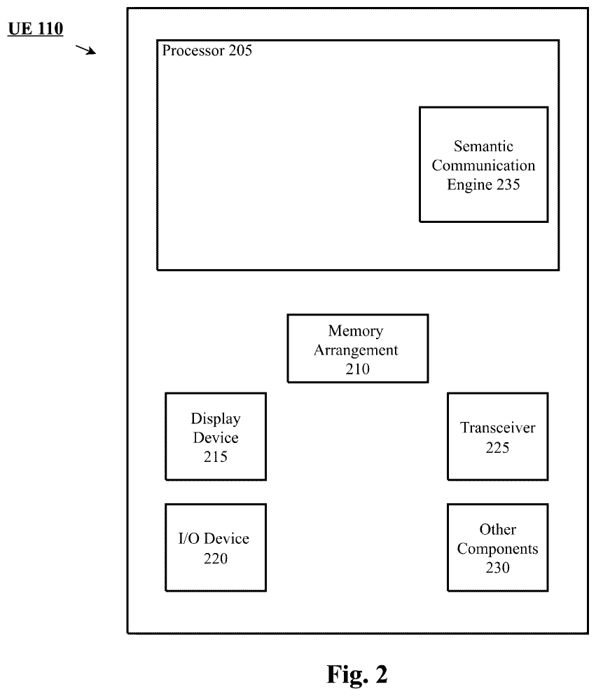

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a semantic communication engine 235. The semantic communication engine 235 may perform various operations related to both encoding and decoding semantic communications by the UE 110. To provide some general examples, the semantic communication engine 235 may perform operations such as, but not limited to, semantic encoding of input data, determining semantic sub-flows for the semantic data, adding an information layer to data packets of semantic data, decoding semantic data, etc. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

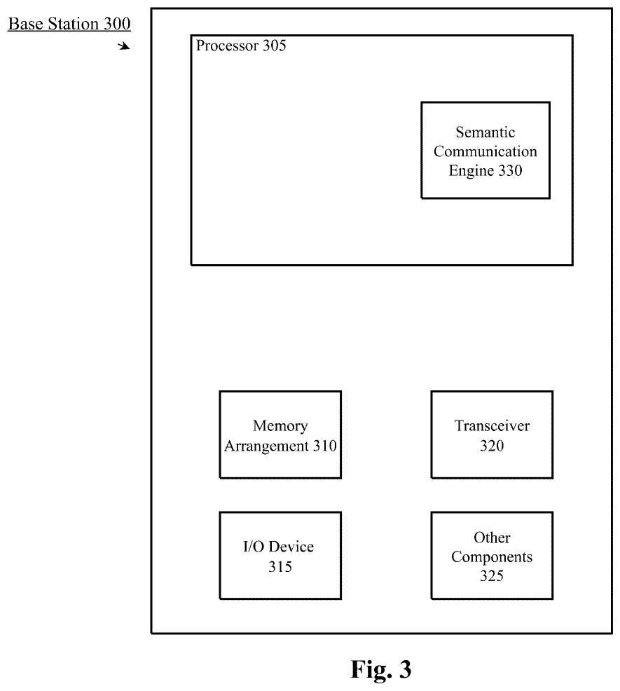

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a semantic communication engine 330. The semantic communication engine 330 may perform various operations for the base station 300 related to semantic communications. To provide some general examples, the semantic communication engine 330 may perform operations such as, but not limited to, extracting data from semantic data packets, reading/writing data to semantic data packets, etc. Each of these example operations will be described in greater detail below.

The above noted engine 330 being an application (e.g., a program) executed by the processor 305 is only an example. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

In a first aspect of the example embodiments, semantic sub-flows are described.

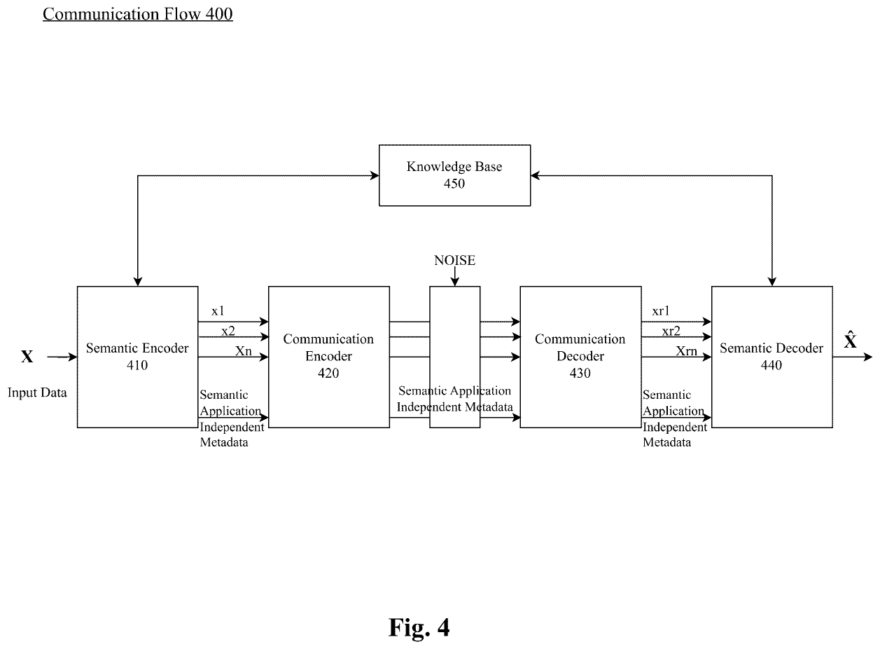

FIG. 4 shows an overview of an example communication flow 400 for semantic sub-flows according to various example embodiments. In this example, the transmitter includes the semantic encoder 410 and the communication encoder 420. The receiver includes the communication decoder 430 and the semantic decoder 440. The knowledge base 450 may be accessible to both the transmitter and the receiver, e.g., may be an artificial intelligence (AI)/machine learning (ML) model maintained separate from the transmitter and receiver or may be maintained locally at both the transmitter and receiver.

As shown in FIG. 4, the transmitter is to send the input data (X) to the receiver. In a first step, the input data is semantically encoded using the semantic encoder 410. As shown in FIG. 4, using the knowledge of the knowledge base 450, the semantic encoder 410 may encode the input data (x) into multiple semantic sub-flows shown as (X1 to Xn) in FIG. 4. Each semantic sub-flow may have a different semantic sub-flow weight (SFW) and may be treated differently in the communication channel when processed by the communication encoder 420. Examples of SFW and factors used for the calculation of the SFW will be described in greater detail below. The semantic encoder 410 may also encode semantic application independent metadata, which is application independent metadata related to each semantic data sub-flow. This metadata may be sent in a separate sub-flow or may be distributed over different sub-flows. As will also be described in greater detail below, a semantic compression factor (SCF) refers to a ratio between the size of input data and a summation of the sizes of the semantic data sub-flows.

The transmitter will transmit the semantic sub-flows to the receiver. As shown in FIG. 4, transmission of the sub-flows will subject the transmissions to noise 460, e.g., over-the-air (OTA) noise in the channel, that may distort the data as it is transmitted. The communication decoder 430 of the receiver will receive the sub-flows and perform corresponding decode operations for the encode operations performed by the communication encoder 420 of the transmitter.

The sub-flows may then be passed to the semantic decoder 440. Similar to the encoding, the receiver may use the knowledge base 450 and the received sub-flows of semantic data to generate the output data (X\hat{ }). X\hat{ } should be equivalent to X but it is not mandatory to be identical to X. Semantic loss (SL) refers to the difference between the generated output (X\hat{ }) and the original input (X). The calculation of SL may consider the weight of each semantic data sub-flow.

As described above, each semantic sub-flow may be assigned an SFW. The SFW refers to the amount of relevant information carried by the semantic sub-flow. The reliability requirement for each semantic sub-flow may be proportional to the SFW, e.g., semantic sub-flows with more relevant information are assigned a higher SFW and have a higher reliability requirement.

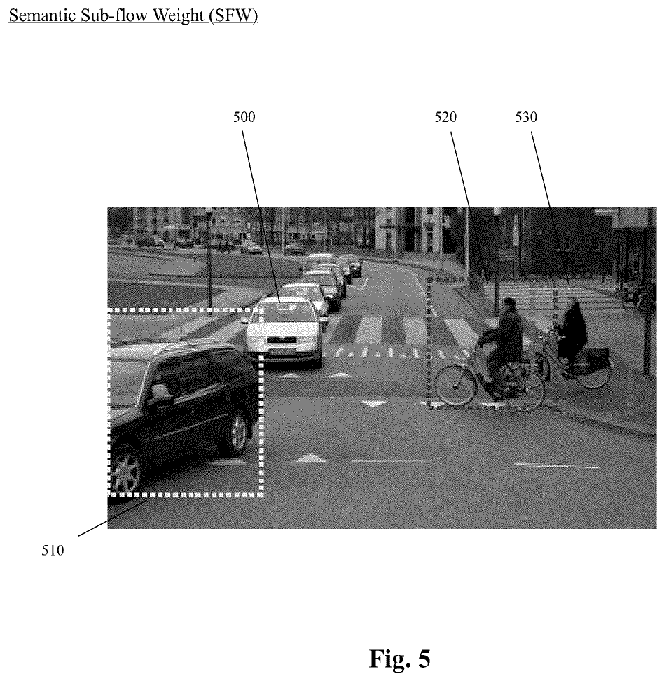

FIG. 5 shows an example of assigning semantic sub-flow weights (SFW) according to various example embodiments. This example may be a vehicle-to-everything (V2X) example. In this example, it may be considered that the transmitter is the vehicle 500, e.g., the vehicle 500 is collecting information about its environment via sensors such as cameras and transmitting this information to a receiver. In this example, it will be considered that semantic information is to be transmitted for three objects, the car 510, the first bicycle 520 and the second bicycle 530. In a real scenario, semantic information may also be transmitted for the other objects detected by the vehicle sensors. However, for the purposes of describing an example of assigning SFW to sub-flows, only these three objects will be considered.

The most relevant information may be that the car 510 is turning right in front of the vehicle 500 and there are two bicycles 520 and 530 passing the way from left to right. Thus, this information may be semantically encoded into a first semantic sub-flow and assigned a highest relative SFW for this example. A next level of information may be information about the car 510, e.g., color, make, model, etc. This information may be semantically encoded into a second semantic sub-flow and assigned a relative SFW that is lower than the SFW for the most relevant information. A further level of information may be information about the persons who ride the bicycles, e.g., faces, clothes, etc. This information may be semantically encoded into a third semantic sub-flow and assigned a lowest relative SFW compared to the other information that is to be transmitted.

Based on the above, it may be considered that the semantic encoder 410 performs the semantic encoding and provides the different semantic sub-flows and semantic metadata such as the SFW of the semantic sub-flows and the relation/dependency between the different sub-flows. The communication encoder 420 uses the semantic metadata to provide a suitable handle for each semantic sub-flow to maximize the SCF and minimize the SL. As will be described in greater detail below, the knowledge base 450 may be used as an interface between the different layers, e.g., semantic layer as embodied by the example semantic encoder 410 and communication layer as embodied by the example communication encoder 420. The communication layers may be application-independent, e.g., the interface between the semantic layer and the communication layer may be the same independent of the type of semantic data, e.g., video, audio, text, etc.

As described above, in addition to the semantic data representing the input data (X), e.g., application data, the semantic encoder may also encode semantic application-independent metadata as shown in FIG. 4. The application-independent metadata may include, for example, the SFW for each semantic sub-flow. For example, application data may be semantically encoded to “N” number of different weighted semantic sub-flows, e.g., N=16. This means that the communication layer should be able to provide different treatment for each semantic sub-flow. The application-independent metadata may also include, for example, sub-flow dependencies. For example, a sub-flow N=8 may provide additional information for data sent over sub-flow N=4. Thus, the transmission of sub-flow N=8 may be impacted by the transmission status of the sub-flow N=4.

In addition to semantic application-independent metadata, there may also be semantic application-dependent metadata, which may be application/semantic layer data that describes how the data from different sub-flows should be used by the semantic decoder 440 to generate the output.

In some example embodiments, the semantic encoder 410 implements a communication abstraction component to control the creation and the dimensioning of semantic sub-flows. For example, the communication abstraction component may dimension sub-flows and configure sub-flow key performance indicators (KPI). These operations may be performed based on, for example, a type of application, e.g., video download, conversational video call, 3D media stream, conversational XR session, voice, text, etc. In another example, a set of the Quality of Service (Qos) or Quality of Experience (QoE) may be assigned to an application.

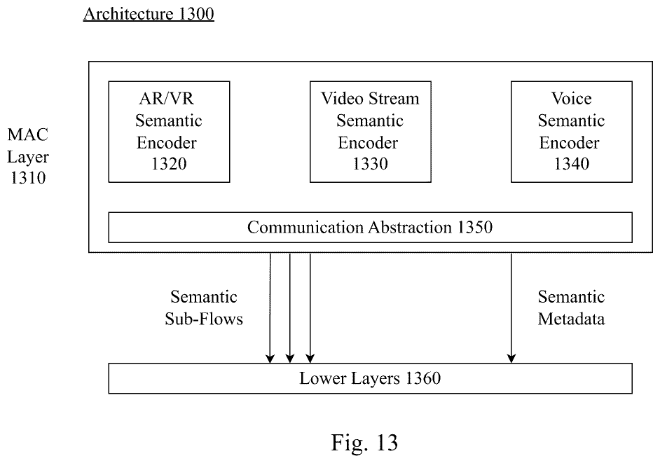

FIG. 13 shows an example architecture 1300 including a communication abstraction component 1350 implemented in a MAC layer 1310 according to various example embodiments. In this example, it may be considered that there are three semantic encoders, AR/VR semantic encoder 1320, video stream semantic encoder 1330 and voice semantic encoder 1340. This is only an example and there may be more or less semantic encoders implemented by a semantic communication system. As described above, the semantic encoders 1320-1340 may semantically encode the input data and generate one or more semantic sub-flows. The communication abstraction 1350 may dimension the semantic sub-flows and configure sub-flow KPIs. As shown in FIG. 13, the semantic sub-flows may carry data and semantic metadata from the upper layers (e.g., MAC layer 1310) to the lower layers 1360 in an application independent manner.

In some example embodiments, the communication abstraction component may assign starting and/or default SFWs for sub-flows. For example, SFW (1)>0 for each sub-flow (1) and SFW (1)=1 for L lossless and N-L lossy sub-flows. The communication abstraction component may also multiplex packets of different semantic encoders to common sub-flow(s), e.g., differentiating the QoE/QOS of the multiplexed application types using per packet weights. In addition, the communication abstraction component may use a standardized formal language to capture the inter-sub-flow dependencies in the semantic metadata sub-flow.

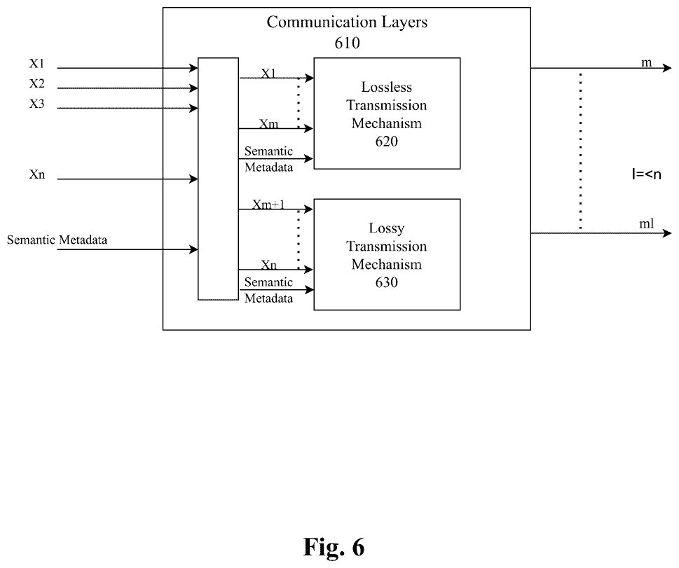

FIG. 6 shows an example of an arrangement 600 of the communication layers for semantic sub-flow transmission according to various example embodiments. In this example, it may be considered that the semantic encoder 410 has separated the input data (X) into the semantic sub-flows X1 . . . . Xn and has generated the semantic metadata that is input into the communication layers 610, e.g., communication encoder 420.

In this example, it may be considered that there are two available transmission mechanisms, lossless transmission mechanism 620 and lossy transmission mechanism 630. The communication layers 610 may distribute the different semantic sub-flows over the two transmission mechanisms 620 and 630 based on the SFW of each sub-flow. For example, the lossless transmission mechanism 620 may be used for relatively high SFW semantic sub-flows and the lossy transmission mechanism 630 may be used for relatively low SFW semantic sub-flows. As shown in FIG. 6, both mechanisms 620 and 630 may include the semantic metadata to provide the correct configuration for each semantic sub-flow.

In some example embodiments, the Radio Link Control (RLC) layer of the communication layers may be modified to handle semantic sub-flows. For example, in traditional RLC acknowledged mode (AM), when a transmit window becomes full, the RLC entity will be stalled and no further Service Data Units (SDUs) can be transmitted until at least one of the SDUs in the transmit window has been fully acknowledged or the maximum number of retransmissions has been reached. In some example embodiments the RLC layer may be modified to include a semantic mode (SM) where, when a transmit window becomes full and based on semantic meta data, the RLC entity may consider the semantic window is successfully transmitted even if some SDUs have not been fully acknowledged.

In some example embodiments, the RLC layer may implement both the AM mode and SM mode for semantic transmissions, e.g., using AM mode for relatively high SFW semantic sub-flows and SM mode for relatively low SFW semantic sub-flows.

As described above, the SFW may be assigned on a per sub-flow basis. However, in some example embodiments, the weight may be assigned on a per packet basis. In such example embodiments, adding the weight to each packet allows all packets to go through the same semantic flow but adds overhead to each packet. The different weights to be used for specific application may be predefined or learned during the session.

In other example embodiments, a hybrid approach may be used where per packet weights (PPW) and per sub-flow weights (SFW) are combined to capture hierarchical semantic relevance. For example, at the top-level the SFW provides relevance of complete features/aspects/areas of the information source by assigning them to separate sub-flows, while at the packet level the PPW allows to shape the ARQ, HARQ, channel coding MCS mechanisms such that an intra-sub-flow profile of tolerable packet loss may be achieved while minimizing channel resources.

A semantic flow may have various requirements such as latency requirements (D [ms]), reliability requirements (e.g., X % of tolerable packet loss), multiple sub-flows (e.g., sub-flow 1—the first lossless sub-flow, sub-flow m—the last lossless sub-flow, sub-flow m+1—the first lossy sub-flow, sub-flow N—the last lossy sub-flow, utility weights β_{f,l}>0 for each sub-flow (l), where Σ_{l=0 . . . N}β_{f,l}=1.

For a pair (UE, semantic flow) a satisfaction level (L) may be achieved when (100−X %) of packets of all sub-flows from 0 to L of the semantic flow are delivered within D [ms]. Thus, [symbol] _{f}(A)∈{ ), . . . , N} may define a maximum achieved satisfaction level for flow (f) of user (u), given the resource allocation A. Furthermore, wᵤ(A):=Σ_{f∈u} [symbol] β_{f,l} is the total utility weight of the delivered sub-flows.

This results in the scheduling optimization problem of U(w₁(A), . . . , wₖ(A))→max_{A}, where U(w₁(A), . . . , wₖ(A)) is a monotonically increasing function in each variable reflecting the UE KPIs and their aggregation and A∈ [symbol] allowed resource allocations in time, frequency and multiplexing domains.

The medium access control (MAC) layer scheduler may take this optimization problem into account when scheduling the semantic sub-flows and as can be seen from the above, the MAC scheduler can take the semantic sub-flows and their weights into account under any existing scheduling policy that is based on a utility-maximization approach.

As described above, the transmitter and the receiver may have access to the knowledge base 450 that allows communicating parties (transmitter and receiver) to learn to communicate effectively towards a given target task/goal. The learning performed by the knowledge base may be separated into two broad categories. A first category may be where the transmitter and receiver agree on a set of possible semantic representations. A second category may be where there is no agreement between the transmitter and receiver. The following will discuss each of these categories of learning.

As stated above, in the first category the transmitter and receiver agree on a set of possible semantic representations, e.g., semantically meaningful features of the image, different video resolutions, generated sensor samples, etc. However, this still leaves many issues to be resolved between the transmitter and receiver such as what semantic representation is most valuable for the receiver to perform a target task, how to achieve effectiveness with a low communication cost, how to guarantee that transmission satisfies timing constraints, etc. Thus, the transmitter and the receiver may add information to the knowledge base 450 to address this issue.

For example, the transmitter and receiver may agree on a target goal/task, the predefined semantic relevance of the data streams for the specific task and the interdependence between the data streams. The knowledge base 450 may then be used to determine what semantic representation to transmit given the priority level of the data streams and how to allocate the network resources in an efficient way to transmit the content for performing the task.

In the second category, the transmitter and receiver may need to cooperatively perform a given task with possible communication. However, a channel model may not be known and may also be noisy. Thus, the transmitter and receiver may learn to communicate effectively with other users by learning what information to transmit, and when, to each user and learn a communication strategy by designing a channel code and modulation to optimize a target task.

For example, the transmission of each representation incurs a given communication cost. The learning may include learning the representation that is most useful for the receiver. This allows the knowledge base to learn the best semantic representation to transmit while minimizing the communication cost and minimizing the execution time.

These learning operations may be federated from multiple transmitters and receivers and may also be an ongoing process as conditions change, e.g., channel conditions, different users, etc.

In some example embodiments, the knowledge base 450 may include complementary knowledge. The complementary knowledge may be information the receiver may use to generate the output (X) with the same semantic meaning as the input (X). The complementary knowledge may contain references, images, videos, 3D models, etc., based on the type of the semantic session (semantic video call, AR/VR semantic session, etc.) and the user configuration. The complementary knowledge may be shared with the receiver at the beginning or during the semantic session or it may be preconfigured and stored in the receiver side before the start of the session.

As stated above, the knowledge base 450 including the complementary knowledge may be generated from multiple UEs or devices involved in semantic communication. However, the knowledge base 450 may encompass a large amount of data and sharing the knowledge base 450 during the semantic session between the transmitter and the receiver may add a significant amount of overhead to the session that may eliminate some of the advantages of semantic communications. On the other hand, having all receivers permanently store the knowledge base 450 may be impractical because of the memory requirements.

In some example embodiments, the ML model and complementary knowledge (e.g., knowledge base 450) may be shared between applications from the same category. This may significantly reduce the amount of ML models and complementary knowledge used to enable semantic communication.

To enable the sharing of the ML Model and complementary knowledge between applications, the system may provide a common framework which may be used by different applications, e.g., provide a semantic kit that includes APIs to allow applications to use common ML and complementary knowledge stored in the device. The framework may include ML models for different application categories and may provide an interface to allow the user to configure the semantic kit to provide the data used to generate the complementary knowledge. Some applications may still build their own ML model and complementary knowledge but this will be less efficient and consume more resources.

The ML model for each application category may be a complex model to perform the end to end semantic encode/decode functionality or it may be a module with multiple ML models where each model performs semantic encode/decode functionality for a specific data type. For example, AR/VR semantic encoder/decoder may include multiple ML models. The same is valid for complementary knowledge.

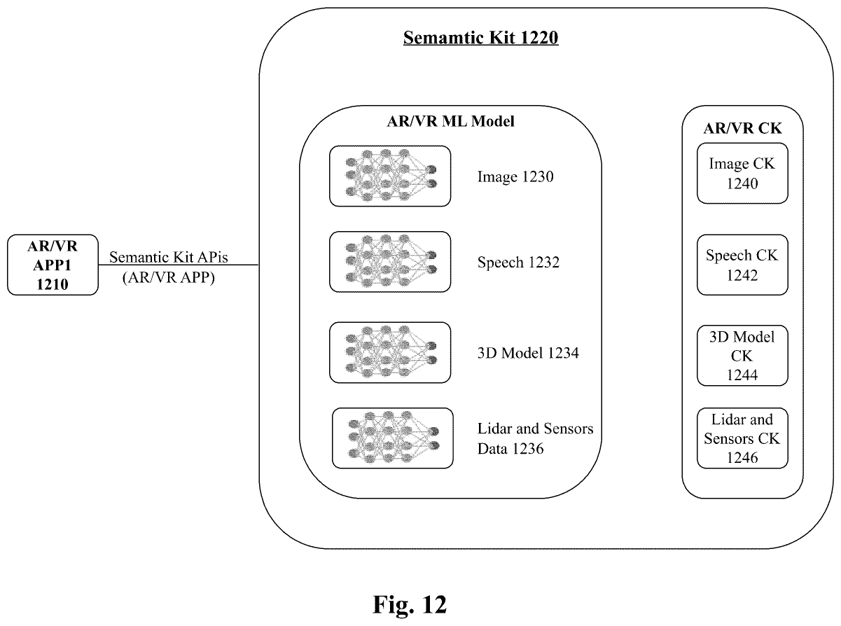

FIG. 12 shows an example of a semantic kit for an AR/VR application category according to various example embodiments. As stated above, in some examples, a module with multiple ML models may be used for an application category where each model performs semantic encode/decode functionality for a specific data type. FIG. 12 shows an example of this arrangement. For example, the application 1210 may be an AR\VR application that may use the semantic kit 1220. The semantic kit 1220 may include multiple ML models 1230-1236 that each may be applied to different types of data used by the application 1210, e.g., image, speech, 3-D model, sensor data, etc. Similarly, the semantic kit 1220 may also include complementary knowledge 1240-1246 for the corresponding data types.

In other example embodiments, the ML model and complementary knowledge (e.g., knowledge base 450) may be shared using a cloud based solution. As described above, storing complementary knowledge for different users and different applications may add significant overhead on the device storage. Thus, a cloud based solution may be used to keep the complementary knowledge stored in a server and share it with an end user when needed.

In some example embodiments, an application specific cloud server may be used. For example, each application may maintain a complementary knowledge server to store the complementary knowledge related to the application. In other example embodiments, a common server may be used. For example, a manufacturer of the UEs, a third party, a carrier, etc., may maintain a cloud server to store the complementary knowledge for all applications. In these examples, the user may only have to interact with one server and duplication of complementary knowledge for different applications may be avoided.

In some example embodiments, the user may select to store a local copy of some complementary knowledge. For example, if the user frequently uses a particular application, the user may select to store the corresponding complementary knowledge to reduce repeated retrievals of the same complementary knowledge. In another example, complementary knowledge related to ultra-reliable low latency communications (URLLC) may be stored locally to reduce latency in retrieving the complementary knowledge.

To preserve user privacy, the user should encrypt the complementary knowledge before storing it on the server. The complementary knowledge server should not be able to decrypt the complementary knowledge. The source of the complementary knowledge should encrypt the complementary knowledge and share the key with all users who need to download the complementary knowledge.

In a second aspect, the example embodiments provide a Traffic Dependent-Communication Optimization (TDCO) layer for transmission of sematic data. The TDCO may be used for transmission of the semantic sub-layers as discussed above but may also be applied to transmissions of semantic data using other transmission methods.

The TDCO may provide the communication layers with more information about traffic to enhance the overall performance of the communication system by considering the different data characteristics (e.g., priority) in scheduling, retransmission, packet discarding, etc. Informing the network about application specific information may impact user privacy, therefore it is better to inform the network about traffic characteristics than application specific information. In addition, informing the network with application specific data makes the network application dependent which means that the network may have to adapt with any new application requirements.

To be able to enhance the communication system without providing the network with application specific data, the example embodiments provide a standard mechanism to share the traffic characteristics with the communication system without providing application specific data and without impacting user privacy. Sharing traffic characteristics with different communication layers in the same entity (e.g., UE) could be easily achieved through defined APIs but the problem is how to share such information between different entities, e.g., between the UE and the base station. The following description of the TDCO addresses these issues.

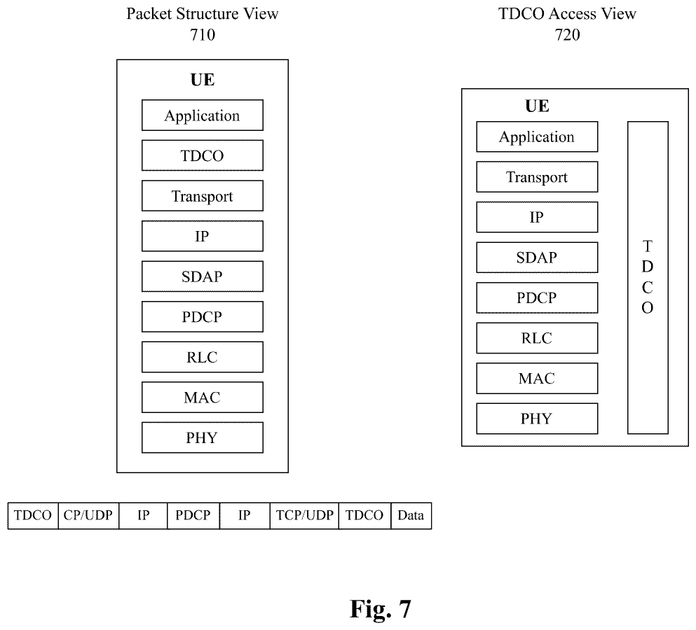

FIG. 7 shows an example of a Traffic Dependent-Communication Optimization (TDCO) layer within layer structure of a UE according to various example embodiments. FIG. 7 shows both a packet structure view 710 and a TDCO access view 720.

The TDCO layer may be considered to be a thin layer between the application and transport layer. From the perspective of the packet structure 710, the TDCO is located just after the application data. From the perspective of the architecture (e.g., access view 720), the TDOC layer may be considered as a cross layer header as all layers may be able to access (read/write) in that header. All entities that support a TDOC layer may read/write in that header and optimize the communication procedures accordingly. All entities that do not support a cross layer header will not be aware of the format and, in some cases, even about the existence of the TDCO, e.g., the entities that do not support the TDCO may consider the header as a part of the payload.

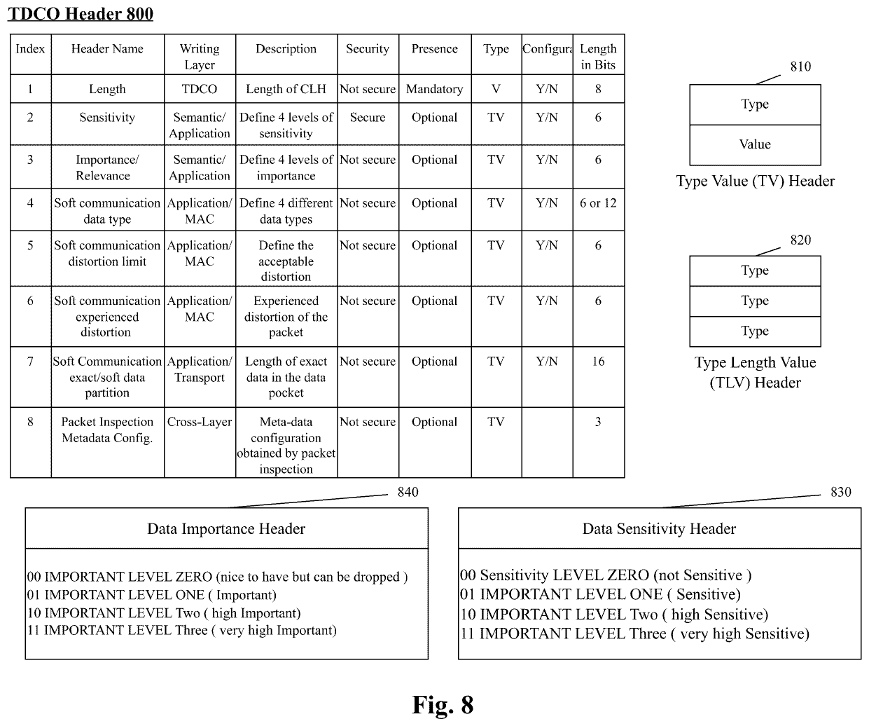

FIG. 8 shows an example TDCO header 800 including a format of the header and example information that may be included in the TDCO header 800 according to various example embodiments. As can be seen from the example, various types of information may be included in the TDCO header. Examples include data type values 810, data type length values 820, data sensitivity 830, data importance 840, etc. As described above, various entities participating in a transmission such as a UE, a base station, the core network function of a cellular network, network servers, routers, etc. that support TDCO may read/write to the TDCO header for the purpose of optimizing the transmission. Those skilled in the art will understand how the TDCO information such as the information shown in FIG. 8 may be used by the various entities to improve communications.

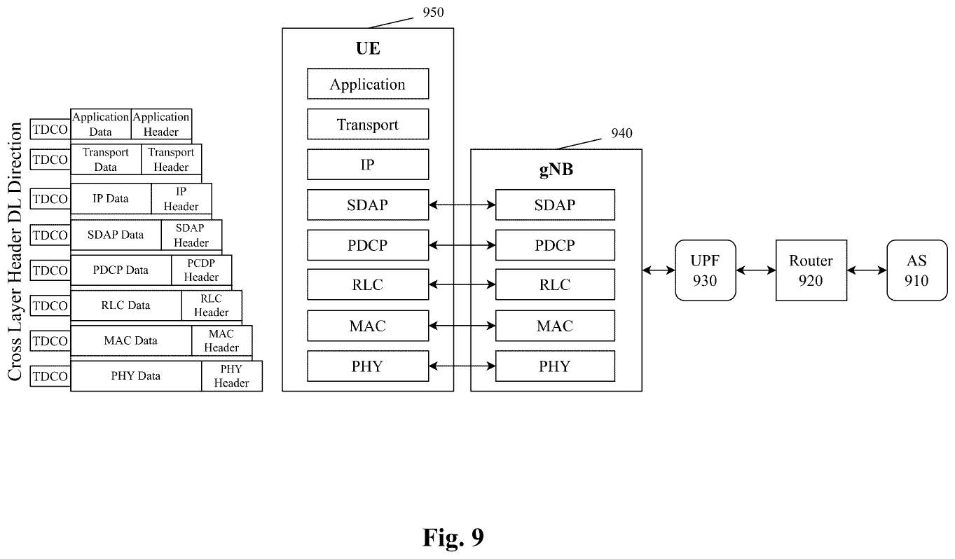

FIG. 9 shows an example of using the TDCO in the downlink (DL) according to various example embodiments. In the example of FIG. 9, it may be considered that the transmission originates with the application server (AS) 910 and is destined for the UE 950. The transmission traverses a router 920, the user plane functions (UPF) 930 of a cellular network and a base station (e.g., gNB 940) of the cellular network on its journey from the AS 910 to the UE 950.

Different layers in AS 910 may add the TDCO header to the packet to be transmitted. In this example, it may be considered that the router 920 supports the TDCO layer and uses the information in the TDCO to enhance the routing procedure. However, as described above, there may be some entities (e.g., legacy routers) that do not support TDCO and may consider the TDCO layer as part of upper layer data.

The UPF 930 supports the TDCO and may perform various actions based on the information included in the TDCO. For example, the UPF 930 may copy TDCO information to a general packet radio service (GPRS) Tunnelling Protocol (GTP) header, add information about the position of the TDCO in the packet to the GTP header, etc.

The gNB 940 may check the TDCO information in the TDCO header or the GTP header and may perform various actions based on the information included in the TDCO. For example, these actions may include packet discarding, retransmission mechanisms, etc. In other examples, the gNB 940 may copy the TDCO information to a MAC header, and add information about the position of the TDCO in the packet to the MAC header.

Finally, the communication layer in the UE 950 may access the TDCO information and perform operations using the TDCO information.

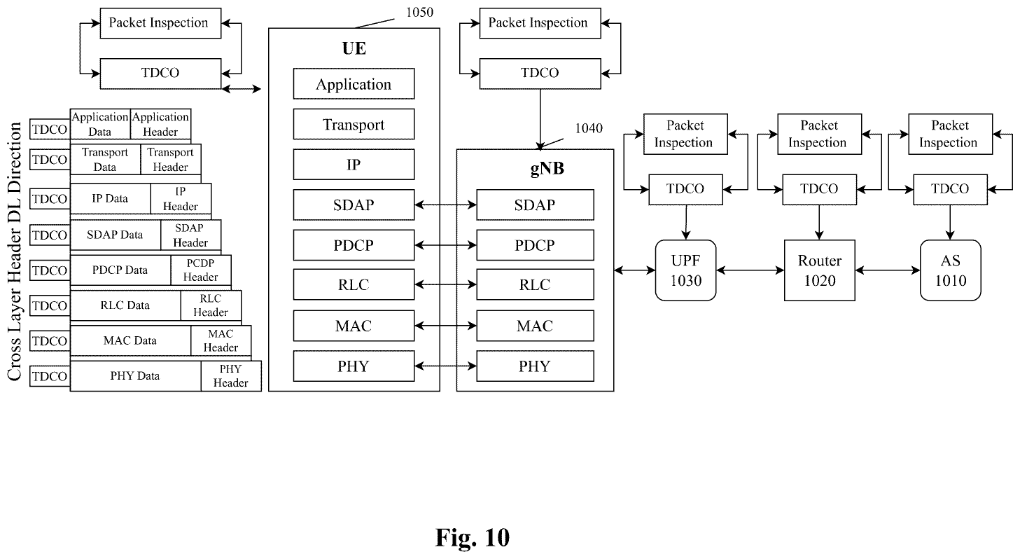

FIG. 10 shows an example of using the TDCO with a packet inspection enhancement in the downlink (DL) according to various example embodiments. The example of FIG. 10 is similar to the example of FIG. 9 where it is considered that the transmission originates with the application server (AS) 1010 and is destined for the UE 1050. The transmission traverses a router 1020, the user plane functions (UPF) 1030 of a cellular network and a base station (e.g., gNB 1040) of the cellular network on its journey from the AS 1010 to the UE 1050. The operations of the entities with respect to the TDCO header may be similar to that described above with reference to FIG. 9.

However, in addition to the TDCO header, in this example embodiment, some or all of the entities involved in the transmission may use packet inspection to extract various header fields to identify the metadata of the application PDU. This information may be combined with the TDCO information for various packet handling procedures.

For example, the UPF 1030 may extract header information such as destination and source IP addresses, destination and source port addresses, IP header urgent pointer, etc., along with the information obtained from the TDCO to configure protocol procedures such as packet handling, retransmission, DRB-flow mapping, etc. The use of the UPF 1030 is only an example as other entities as shown in FIG. 10 may also use packet inspection based meta-data extraction combined with TDCO based information extraction.

In some example embodiments, the information included in the TDCO may be modified, updated or removed based on the metadata obtained as a result of the packet inspection per network entity. For example, the entity may initially perform packet inspection, and based on the extracted metadata, the corresponding fields in TDCO may be modified. To provide a specific example, at the UPF 1030, based on the source-destination IP addresses, IP header urgent pointer, etc., some of the information fields (or information elements) in TDCO can be modified, such as the packet information level as shown in the example of FIG. 8.

The TDCO packet header may also include an information element to identify which header names and categories can be modified based on the packet inspection procedure in a given network entity. The modifiability of the TDCO packet header names and their contents may be the same throughout the network, the application, or may be network entity dependent. The modifiability of the TDCO packet header names and their contents may be included as part of the TDCO header information, e.g., packet inspection metadata configuration as shown by index 8 in the example TDCO format of FIG. 8.

In other example embodiments, the TDCO content may be used to identify packet inspection procedures, e.g., which particular headers and information elements in those headers the network entity should perform packet inspection. For example, a higher level in packet sensitivity (TDCO header name index: 2 in FIG. 8) in the TDCO header may imply a packet inspection to include TCP header fields, whereas a lower level in packet sensitivity may imply otherwise.

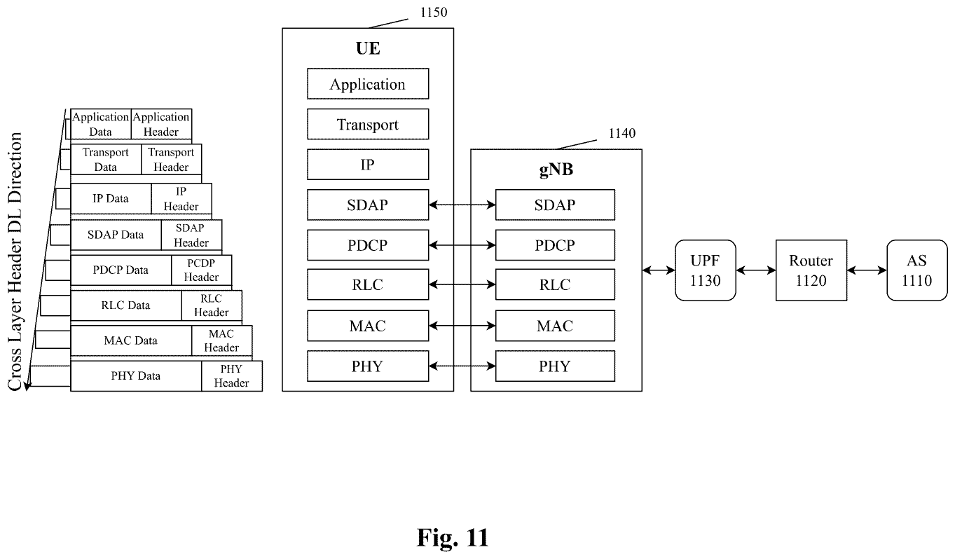

FIG. 11 shows an example of using the TDCO in the uplink (UL) according to various example embodiments. In the example of FIG. 11, it may be considered that the transmission originates with the UE 1150 and is destined for the application server (AS) 1110 and is destined for the. The transmission traverses a base station (e.g., gNB 1140) of a cellular network, a user plane functions (UPF) 1130 of the cellular network and a router 1120 on its journey from the UE 1150 to the AS 1110. Thus, the UL transmission is in the opposite direction from the DL transmission described with reference to FIG. 9.

In this example, the different layers in the UE 1150 may add the TDCO header to the packet to be transmitted including the classification of the UL data based on the TDCO. In the UL, the TDCO layer in the UE may be responsible for setting the size of the TDCO header, setting the security level of the TDCO header (secured, partially secured or unsecured) or setting the TDCO header by traffic default values, e.g., based on input from the application layer.

Any layer in the UE 1150 may update part of the TDCO header based on an access policy. If the TDCO includes sensitive information, the TDCO header may include a secured part for the sensitive information that may be accessed by the Packet Data Convergence Protocol (PDCP) layer and above. In contrast, a non-secured part of the TDCO may contain non sensitive information that may be accessed by all layers

Write access of each element in TDCO header defines which layer could modify this element

The gNB 1140, when receiving the packet with the TDCO header may perform various operations based on the TDCO information. In one example, where the semantic communications are using sub-flows, the gNB 1140 may use the sub-flow information (e.g., sub-flow metadata) and the TDCO information to perform the operations. The remaining entities in the transmission flow may also use the TDCO information as described above.

The TDCO is not a replacement of a layer specific header but may be used to enhance the user experience, e.g., by providing additional information about the flow so different entities may act accordingly when routing the packet through a network. The TDCO may be optional, e.g., there is no requirement to add the TDCO to semantic transmissions. For example, a complete TDCO header may be added to a transmission, a partial TDCO header may be added to a transmission, no TDCO header may be added to a transmission. Furthermore, the TDCO may not include application specific information or user sensitive information.

In some example embodiments, the TDCO header may only be used in the DL.

In some example embodiments, the TDCO layer may be inserted before the Internet Protocol (IP) layer. This may avoid any impact of encryption in the transport layer. In these example embodiments, the protocol field (IPv4) or next header field (IPv6) may refer to TDCO where the TDCO may be added as a new transport protocol. The TDCO may also include an additional field for the next header to refer to the next header, e.g., UDP or TCP.

In other example embodiments, the TDCO may be considered as part of the IP header, e.g., options field or DSCP field in IPv4, or destination options or traffic classes in IPv6. Implementing these example embodiments may depend on the behavior of different modules in the IP network (e.g., routers) that may ignore these fields or block the packet as some routers may consider the option fields as a potential risk.

In still further example embodiments, the TDCO may be considered as part of other transport protocols, e.g., TCP, QUIC, etc. In these examples, different transport protocols should be updated to consider TDCO requirements.

### EXAMPLES

In a first example, a method, comprising receiving input data, processing, by a semantic encoder, the input data to generate a semantic representation of the input data, wherein the semantic representation comprises multiple semantic sub-flows, wherein each semantic sub-flow comprises a semantic weight corresponding to a relevance of the semantic data, processing, by a communication encoder, each of the semantic sub-flows to generate semantic transmissions corresponding to the semantic sub-flows, wherein characteristics of the semantic transmissions are based on the semantic weight of the corresponding semantic sub-flow and preparing, for transmission to the receiver, the semantic transmissions.

In a second example, the method of the first example, wherein the semantic encoder accesses a knowledge base to generate the semantic representation.

In a third example, the method of the second example, wherein the knowledge base comprises an (ML) model that incorporates information from the UE and the receiver.

In a fourth example, the method of the third example, wherein the ML model is trained based on a target goal determined between the UE and the receiver.

In a fifth example, the method of the third example, wherein the ML model is trained based on a determining relevant semantic representations for performing a task.

In a sixth example, the method of the third example, wherein the ML model is further used to assign the semantic representation to the semantic sub-flows based on the semantic weight of the sub-flows.

In a seventh example, the method of the third example, wherein the knowledge base further comprises complementary knowledge used by the receiver to decode the semantic representation.

In an eighth example, the method of the seventh example, wherein the knowledge base comprising the ML Model and complementary knowledge is shared between applications from a same category.

In a ninth example, the method of the seventh example, further comprising generating, for transmission to a server storing the knowledge base, information that is to be included as part of the ML model or complementary knowledge, wherein the information is encrypted prior to transmission.

In a tenth example, the method of the ninth example, further comprising generating, for transmission to one or more users, a key to decrypt the encrypted information.

In an eleventh example, the method of the first example, wherein the semantic representation further comprises semantic application-independent metadata that indicates the weight for each of the multiple semantic sub-flows or a dependency between two or more semantic sub-flows.

In a twelfth example, the method of the first example, wherein the semantic representation further comprises semantic application-dependent metadata that indicates how data from each of the sub-flows is to be used by a semantic decoder of the receiver to generate the output.

In a thirteenth example, the method of the first example, wherein the communication encoder assigns each of the semantic sub-flows to a lossless transmission mechanism or a lossy transmission mechanism.

In a fourteenth example, the method of the first example, further comprising determining, by a radio link control (RLC) layer, when a transmit window is full, at least one service data unit (SDU) of the semantic representation is successfully transmitted without receiving a fully acknowledged indication for the SDU, wherein the determination is based on the weight of the corresponding semantic sub-flow.

In a fifteenth example, the method of the first example, wherein each data packet of the semantic representation comprises a further weight.

In a sixteenth example, a processor configured to perform any of the methods of the first through fifteenth examples.

In a seventeenth example, a user equipment (UE) configured to perform any of the methods of the first through fifteenth examples.

In an eighteenth example, a method, comprising receiving input data, processing the input data to generate a semantic representation of the input data and generating, for transmission to a receiver, a data packet to transmit a portion of the semantic representation, wherein the data packet comprises a Traffic Dependent-Communication Optimization (TDCO) header including traffic characteristics of the semantic representation.

In a nineteenth example, the method of the eighteenth example, wherein the TDCO header is added by a TDCO layer that is below an application layer and above a transport layer of a protocol stack of a user equipment (UE).

In a twentieth example, the method of the eighteenth example, further comprising setting a size of the TDCO header, setting a security level of the TDCO header or setting the TDCO header based on traffic default values.

In a twenty first example, the method of the eighteenth example, wherein the TDCO header comprises a secured part and a non-secure part.

In a twenty second example, the method of the eighteenth example, wherein the traffic characteristics comprise a data type value, a data type length value, a data sensitivity or a data importance.

In a twenty third example, the method of the eighteenth example, wherein the TDCO header is added by a TDCO layer that is below a transport layer of a protocol stack of the UE.

In a twenty fourth example, the method of the eighteenth example, wherein the TDCO header is added by a TDCO layer that is part of an Internet Protocol (IP) layer or transport layer.

In a twenty fifth example, a processor configured to perform any of the methods of the eighteenth through twenty fourth examples.

In a twenty sixth example, a user equipment (UE) configured to perform any of the methods of the eighteenth through twenty fourth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
receive input data;
process, by a semantic encoder, the input data to generate a semantic representation of the input data, wherein the semantic representation comprises multiple semantic sub-flows, wherein each semantic sub-flow comprises a semantic weight corresponding to a relevance of the semantic data;
process, by a communication encoder, each of the semantic sub-flows to generate semantic transmissions corresponding to the semantic sub-flows, wherein characteristics of the semantic transmissions are based on the semantic weight of the corresponding semantic sub-flow; and
prepare, for transmission to the receiver, the semantic transmissions.

2. The apparatus of claim 1, wherein the semantic encoder accesses a knowledge base to generate the semantic representation.

3. The apparatus of claim 2, wherein the knowledge base comprises an (ML) model that incorporates information from a user equipment (UE) and the receiver.

4. The apparatus of claim 3, wherein the ML model is trained based on a target goal determined between the UE and the receiver.

5. The apparatus of claim 3, wherein the ML model is trained based on a determining relevant semantic representations for performing a task.

6. The apparatus of claim 3, wherein the ML model is further used to assign the semantic representation to the semantic sub-flows based on the semantic weight of the sub-flows.

7. The apparatus of claim 3, wherein the knowledge base further comprises complementary knowledge used by the receiver to decode the semantic representation.

8. The apparatus of claim 7, wherein the knowledge base comprising the ML Model and complementary knowledge is shared between applications from a same category.

9. The apparatus of claim 7, wherein the processing circuitry is further configured to:
generate, for transmission to a server storing the knowledge base, information that is to be included as part of the ML model or complementary knowledge, wherein the information is encrypted prior to transmission.

10. The apparatus of claim 9, wherein the processing circuitry is further configured to:
generate, for transmission to one or more users, a key to decrypt the encrypted information.

11. The apparatus of claim 1, wherein the semantic representation further comprises semantic application-independent metadata that indicates the weight for each of the multiple semantic sub-flows or a dependency between two or more semantic sub-flows.

12. The apparatus of claim 1, wherein the semantic representation further comprises semantic application-dependent metadata that indicates how data from each of the sub-flows is to be used by a semantic decoder of the receiver to generate the output.

13. The apparatus of claim 1, wherein the communication encoder assigns each of the semantic sub-flows to a lossless transmission mechanism or a lossy transmission mechanism.

14. The apparatus of claim 1, wherein the processing circuitry is further configured to:
determine, by a radio link control (RLC) layer, when a transmit window is full, at least one service data unit (SDU) of the semantic representation is successfully transmitted without receiving a fully acknowledged indication for the SDU, wherein the determination is based on the weight of the corresponding semantic sub-flow.

15. The apparatus of claim 1, wherein each data packet of the semantic representation comprises a further weight.

16. An apparatus comprising processing circuitry configured to:
receive input data;
process the input data to generate a semantic representation of the input data; and
generate, for transmission to a receiver, a data packet to transmit a portion of the semantic representation, wherein the data packet comprises a Traffic Dependent-Communication Optimization (TDCO) header including traffic characteristics of the semantic representation.

17. The apparatus of claim 16, wherein the TDCO header is (i) added by a TDCO layer that is below an application layer and above a transport layer of a protocol stack, (ii) added by a TDCO layer that is below a transport layer of a protocol stack or (iii) is added by a TDCO layer that is part of an Internet Protocol (IP) layer or transport layer.

18. The apparatus of claim 16, wherein the processing circuitry is further configured to:
set a size of the TDCO header;
set a security level of the TDCO header; or
set the TDCO header based on traffic default values.

19. The apparatus of claim 16, wherein the TDCO header comprises a secured part and a non-secure part.

20. The apparatus of claim 16, wherein the traffic characteristics comprise a data type value, a data type length value, a data sensitivity or a data importance.
